(19) United States
(12) Patent Application Publication
(10) Pub. No.: US 2013/0339104 A1
(43) Pub. Date: Dec. 19, 2013

(54) TECHNICAL PLATFORM

(71) Applicant: SAM G. BOSE, Stapleford (GB)

(72) Inventor: SAM G. BOSE, Stapleford (GB)

(21) Appl. No.: 13/917,648

(22) Filed: Jun. 14, 2013

Related U.S. Application Data
(60) Provisional application No. 61/660,125, filed on Jun. 15, 2012.

(30) Foreign Application Priority Data
Nov. 21, 2012 (GB) GB1220941.7

(51) Int. Cl. G06Q 10/06

(52) U.S. Cl. CPC G06Q 10/0637
USPC 705/7.37; 705/7.36

(57) ABSTRACT

A technical platform for providing technical services comprises a hardware arrangement which is operable to sense real-time data and/or signals occurring within at least one facility, and to transmit the real-time data and/or signals through communication medium, wherein the hardware arrangement is operatively connected to control and/or infrastructure layers for implementing overall control and responses to the real-time data and/or signals, and a pre-programmed service layer which is operable to receive and utilize the responses for management purposes for providing the technical service.

### TECHNICAL PLATFORM

The present invention relates a technical platform for creating asset intelligence and enterprise intelligence which is connected through end user software applications.

### BACKGROUND

A major contemporary problem faced by industry as well as the human population is a crisis in natural resources, for example in respect of energy and water resources. With increasing consumption and diminishing natural resources such as oil and coal for generation of energy, an energy crisis looms in the twenty first century. With such increasing consumption and limited supply of natural resources, prices of fuel and electricity are surging. Hence, effective management to cut energy consumption is a prime concern of industry and individuals alike.

Technological solutions aimed at reducing consumption of energy have always been needed. Moreover, with rapid developments in electronic technologies, automatization of assets has been largely improvised upon with an aim of reducing energy consumption and improving asset condition. Development of improved actuators and sensors has helped in collecting load data for achieving efficient monitoring of different assets. Contemporary electrical apparatus such as pumps, heaters, and air conditioners possess inbuilt mechanisms for lowering energy consumption. The mechanisms involve a simple set of sensors and pre-programmed controllers for providing effective energy management. There are large amounts of data from these contemporary electrical apparatus and other business processes across industries today, while the energy consumption is enormous and ever increasing.

It is desirable that multiple assets that consume electrical energy need to be monitored concurrently, as well as demand drivers for these multiple assets need to be monitored, so that the asset is optimized when accommodating changing demand, thereby potentially reducing consumption of energy. A single sensor micro-controller network for an asset is not suitable for industries or buildings having infrastructures possessing a huge network of assets whose demand is driven by multiple complex factors. Overall mentoring and analysis systems are needed for such networks, which can control a multiplicity of assets and derive intelligence from the asset performance data. Moreover, for achieving efficient monitoring of electrical and mechanical assets in a very efficient manner, relevant consumption data needs to be collected over a long period of time, wherefrom an accurate probabilistic model of effective consumption in various scenarios can be designed, as well as optimum efficient solutions can be designed. Thus, there is an inherent need in the art for system integration and collective monitoring of all electrical and mechanical assets of a given infrastructure or an industry, through a single technical platform.

In a published United States patent application no. US 2011 004446 A, there is disclosed an intelligent network for providing controls to various end points of an infrastructure. The network includes a plurality of sensors located throughout an industrial system. Intelligent responses are generated from data collected from various parts of an industrial chain. However, such intelligent responses are mostly pre-programmed and provide a limited set of outputs to few stipulated responses. Moreover, such networks do not collect data on a variety of related operating parameters apart from asset performance and thus provide a limited improvement. These systems also do not integrate with traditional enterprise resource planning system thus management and operations teams cannot have a complete picture of their business.

Known management systems for controlling assets in industrial facilities are often proprietary in nature and are not tuned to interact operatively with other external systems. Most of these systems do not track energy consumption and do not provide real time control based on dynamically changing demand. Such known systems are based on preset controls. Furthermore, they are primarily implemented as hardware installed at customer premises.

Other assets such as solar panels are monitored and optimized at an array level and not at an individual level. Such array level perspective results in a lack of clarity regarding a performance of each solar panel. Moreover, shading and dirt on one given solar panel is potentially capable of adversely affecting a current output of an entire associated string of solar panels. Such adverse effect has a potential of reducing energy output from the entire string of solar panels.

Contemporary demand response services are often manual in nature. For example, in a morning period, a utility sends an e-mail: xl sheet highlighting power consumption for a peak period during a day. Based on such an e-mail, a facility manager either switches on or switches off specific equipment. By implementing such selective timed switching of equipment, the facility is enabled to earn credits in their monthly energy bill, for example by way of providing peak demand shaving. However, there is a lack of provision for the facility manager to identify which equipment should be switched on or switched off to have a most efficient demand response strategy based on a demand scenario for the day in an associated building or industrial facility.

Contemporary industrial oil and gas fields, as well as water utilities, employ relatively low technology measures for identifying wall thicknesses and leaks in pipelines. Typically, manual inspection of pipelines is undertaken with limited access to areas that are physically difficult to access. There is also limited ability to store thickness data in a granulated and regular form.

Accordingly, there is a long felt need to provide a technical platform which at least partially solves aforementioned problems, and which provide existing assets with intelligence; moreover, there is a long felt need for a technical platform for delivering software applications (apps) by collecting and deriving intelligence, insight from a variety of relevant data from various asset management workflows and generating responses to act therefrom. There is also a need for such a technical platform, which would be effective in a sacrosanct manner in different fields requiring asset and enterprise intelligence and improving overall operating efficiency in respect of processes, people and assets.

The technical platform according to embodiments addresses the aforesaid long felt needs.

Throughout the specification herewith, including the claims, the words “platform”, “infrastructure”, “asset”, “sensor”, “smart system”, “intelligent network”, “response”, “signal”, “relevant data”, “hardware”, “software”, “program”, “operations center”, “control events”, “social assets” and “mobile access” are to be interpreted in the broadest sense of the respective terms and includes all similar items in the field known by other terms, as may be clear to persons skilled in the art. Restriction/Limitation if any, referred to in the specification, is solely by way of example and understanding the present invention.

### SUMMARY

It is the principal object of the present disclosure to provide a technical platform, which is operable to monitor intelligently, interpret various types of operational data and optimize, a plurality of assets and associated industry system, embracing a wide range of technical fields in a sacrosanct manner.

It is a further object of the embodiments to provide a technical platform, which is adapted to collect large-scale real-time operating data from various assets over a period of time, and to analyze them to generate intelligent real time control events based on the same.

It is yet another object of the embodiments to provide a technical platform which is adapted to lower substantially power consumption of various one or more facilities containing one or more assets by functioning intelligently in a manner that is matched against changing demand patterns.

It is a further object of the embodiments to provide a technical platform, which offers software application (apps) that combine enterprise intelligence from existing enterprise systems with asset intelligence to users, and asset owners based on intelligent operation of one or more assets.

It is further an objective of the embodiments to compare the real-time operating data of one or more assets against non real-time operating data for the same or similar assets to improve the overall performance of the one or more assets throughout the facility when operating as an overall system.

It is yet another object of the embodiments to provide a technical platform which reduces and/or optimizes energy consumption.

It is a further object of the embodiments to provide a technical platform, which is accessed and operated through wireless communication networks such as contemporary proprietary Wireless HART, Mesh network and Weightless spectrum.

How the foregoing objects are achieved and other aspects of the embodiments will be clear from the following description, which is purely by way of understanding and not by way of any sort of limitation to a scope of protection which is sought.

According to a first aspect of embodiments, there is provided a technical platform for providing technical services as claimed in claim 1: there is provided a technical platform for providing technical services, wherein the technical platform comprises a hardware arrangement which is operable to sense and process real-time data and/or signals occurring within at least one facility, and to transmit the real-time data and/or signals through communication medium, wherein the hardware arrangement is operatively connected to control and/or infrastructure layers for implementing overall control and responses to the real-time data and/or signals, and a pre-programmed service layer which is operable to receive and utilize the responses for management purposes for providing the technical service.

In alternative embodiment, the technical platform also interfaces with existing sensors in wireless communication devices such as tablets, smartphones, laptops or measuring instrumentation to access data, which is then matched with enterprise data to identify intelligence and enable users to take proactive and predictive actions on the operation of the one or more facilities with one or more assets.

The technical platform is of advantage in that it is capable of providing an improved degree of control over assets or systems of the facility for improving their operating efficiency, for example for providing resource utilization cost savings.

According to a second aspect of embodiments, there is provided a method of providing technical services via a technical platform, wherein the method includes:

using a hardware arrangement of the technical platform for sensing real-time data and/or signals occurring within at least one facility;

(ii) transmitting the real-time data and/or signals through communication medium, wherein the hardware arrangement is operatively connected to control and/or infrastructure layers for implementing overall control and responses to the real-time data and/or signals; and

(iii) using a pre-programmed service layer to receive and utilize the responses for management purposes for providing the technical service.

According to a third aspect of the embodiments, there is provided a software product recorded on machine-readable data storage media, wherein the software product is executable upon computing hardware for implementing the method pursuant to the second aspect of embodiments. The software data storage media may be for example servers, DVDs, CDs, Memory sticks, Memory cards, cloud based servers, hard drives, and more. The software product may also source other publicly and non-publicly available relevant data sources and match it with the existing data storage to identify patterns, intelligence and deliver proactive and predictive actions to be taken.

In accordance with preferred embodiments of the technical platform of the embodiments, terms employed above in association with the summary have the following meanings:

| Term | Interpretation |
|---|---|
| “hardware | the hardware arrangement comprises sensors for sensing a plurality |
| arrangement” | of inputs with a microprocessor to analyze the signal and wireless |
| | communicating means for transmitting data/signal received from the |
| | sensors to the control/infrastructure layer |
| “sensors” | the sensors for data acquisition include, for example, audio, pressure |
| | sensors, vibration, and/or temperature sensors and the like such as |
| | herein described, and there is provided an interfacing arrangement for |
| | interfacing with existing analogue sensors |
| “hardware | the hardware arrangement is operable to interface with the existing |
| arrangement” | control/infrastructure to trigger control functions depending on changes |
| | in operating conditions |
| “control and/or | the control/infrastructure layers comprise wireless communication |
| infrastructure | arrangements adapted to set protocols for receiving the data/signal |
| layers” | from the hardware arrangements, a network operations center (NOC), |
| | pre-programmed software system analyzing and responding to the |
| | data/signal intelligently, and a cloud platform for handling data and |
| | time sharing resources of overall infrastructure |
| “service layer” | the service layer is operable to provide recommendations through |
| | “proactive and predictive actions” that act as triggers for appropriate |
| | steps in respect of facility services, such as energy service, and/or |
| | light services, and/or water services, and/or motor, and/or electricity, |
| | and/or LED and/or Carbon Dioxide (CO2) consumption |
| “facility services” | the facility services include a triggering means for enabling facilities |
| | employees to track efficiency of their systems, assets, compare them |
| | with best practice, benchmark them and identify areas of inefficiency |
| | with recommendations for proactive and predictive actions to be taken. |
| “triggering | the triggering arrangement comprises a switch and/or like elements |
| arrangement” | |
| “service layer” | the service layer is operable to trigger steps and initialize responses of |
| | how assets of the facilities are operated; in respect of, for example, |
| | solar services, comprising power boosters for individual solar panels, a |
| | solar charge controller and means for integrating output from solar |
| | panel units to real time operations and maintenance to maximize |
| | output; |
| “triggering | the triggering arrangement comprises a maximum power point tracker |
| arrangement” | |
| “Wireless service” | the Wireless service additionally comprises a wireless and/or Internet |
| | gateway for providing overall control of the system through external |
| | wireless means |
| “service layer” | the service layer is operable to trigger steps in respect of demand |
| | response services in industry with high energy consumption in peak |
| | hours, the response comprising demand forecasting, saving peak |
| | loads, and providing energy credits |
| “technical platform” | the technical platform is operable to be associated with a business |
| | model to deliver a “save-to-pay” model in the manner such as herein |
| | described |

### BRIEF DESCRIPTION OF THE DRAWINGS

Embodiments will now be described, by way of example only with reference to the following drawings, wherein:

FIG. 1 is an illustration of different layers and/or components of a technical platform pursuant to the embodiments;

FIG. 2 is an illustration of a preferred embodiment of a technical platform pursuant to the embodiments applied in a smart building solution;

FIG. 3 is an illustration of another preferred embodiment of a technical platform pursuant to the embodiments applied in a solar panel;

FIG. 4 is an illustration of a further preferred embodiment of a technical platform pursuant to the embodiments applied in a smart demand response;

FIG. 5 is a schematic overview of a facility with which the technical platform pursuant to the embodiments is employed; and

FIG. 6 is a graph having an abscissa axis denoting multi-parameter selection P as a function of an ordinate axis denoting efficiency of operation E of a system being controlled by the technical platform of FIG. 1.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In the following, there are described preferred embodiments of the embodiments, which are purely for the sake of understanding the embodiments and not by way of any sort of limitation.

In brief, the embodiments are not restricted to the fields referred to for the sake of explanation. Rather, the embodiments, as stated hereinbefore, are applicable in a wide range of technical fields, as would be known to persons skilled in the art. The embodiments are applicable in all such fields for maximum utilization of asset management, and derivation of power saving/output pursuant thereto.

As herewith disclosed, the embodiments generally relates to a technical platform, and more specifically to a smart infrastructure technical platform, which is capable of controlling and monitoring a plurality of assets in a power-saving manner. The technical platform performs by collecting operative data over a span of time from the facility, which comprises one or more assets individually monitored with one or more sensors and providing real time smart responses based on changing demand scenarios to lower the overall power consumption of the assets. The technical platform receives, namely senses, the input data, both in real time and in non-real time, and triggers actions that are proactive and predictive by sending responses to the assets allowing them to be run more efficiently or accurately.

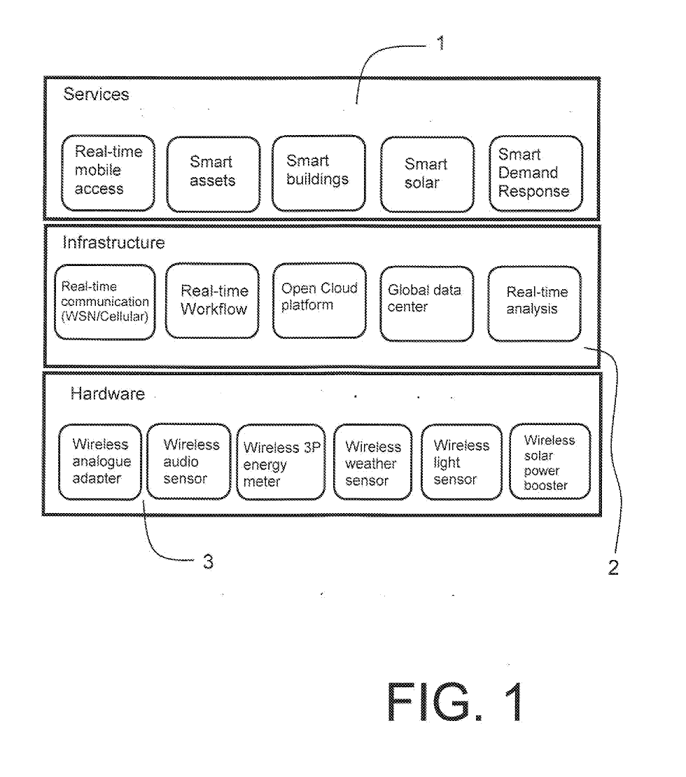

As illustrated in FIG. 1, the technical platform as disclosed in the embodiments includes three major layers and/or components: a hardware layer 1, an infrastructure layer 2 and a service layer 3.

The hardware layer 1 of the disclosed technical platform is designed with following capabilities as provided in Table 1:

TABLE 1
Capabilities of the hardware layer 1

| Capability | Detail |
|---|---|
| Wireless | Wireless enabled sensing devices that transmit data over |
| sensing | different wireless protocols. |
| Interfacing | Interfacing with one or more existing analogue sensors. |
| with sensors | |
| Sensing | Performing a range of sensing functions such as audio |
| function | sensing, temperature sensing, humidity sensing, daylight |
| | sensing, occupancy sensing, energy sensing, pressure |
| | sensing, flow sensing, to plug loads for any energy |
| | consuming equipment. |
| Interfacing | Interfacing with existing control devices to trigger control |
| with control | functions depending upon changes in operating conditions. |
| devices | |

The infrastructure layer 2 consists of a communication and software layer providing following capabilities as provided in Table 2:

TABLE 2
Capabilities of the infrastructure layer 2

| Capability | Details |
|---|---|
| Wireless | Using various wireless protocols in the 802.15.4, 2.4 GHz |
| protocols | and sub-1 GHz band to transmit real-time data. |
| Use of | Using open and standards-based cloud platforms to store |
| platforms | and analyze large volumes of real time data. |
| Network | Having a network operations center (NOC) that monitors |
| operations | and manages all the wireless networks deployed in field |
| center | locations. |
| Real time | Possessing capability to deliver real-time intelligence by |
| intelligence | analyzing and correlating diverse data sets. |
| Designing | Designing asset management workflows for different asset |
| workflows | types with decision-making driven from data intelligence |
| | through “control events” |
| Demand | Having a Demand Response (DR) gateway that connects to |
| Response | utility pricing systems and controls facilities assets during |
| (DR) | peak periods of resource consumption. |
| gateway | |

As illustrated in FIG. 1, the services layer 3 is an end user services layer where value is delivered to customers from the smart technical platform as provided in Table 3:

TABLE 3
Services delivered from the services layer 3

| Service | Detail |
|---|---|
| Facilities | the facilities include, for example, at least one of: Microfabrication plants, |
| | Manufacturing plants, Steel mills, Water treatment works, Assembly |
| | factories, and Power stations. |
| Asset with | by providing sensing and connectivity to real World assets such as motors, |
| intelligence | pumps, analogue sensors, pipelines, factories and so forth, various |
| | initiatives such as proactive and predictive maintenance, energy efficiency, |
| | field service management and real time demand/supply which are |
| | implemented in commercial and industrial markets. |
| Smart | by providing sensing and real-time control capability to individual assets |
| facilities | such as chillers, pumps, and heating systems in a facility, a portfolio of smart |
| | facility services is delivered. Each service results in a reduction in energy |
| | consumption, water consumption, CO2 emission in the facility or system, |
| | improving facility or system condition and providing real-time status |
| | information to operational staff through web and mobile platforms. The |
| | smart facilities service consists of individual solutions, for example smart |
| | water, smart energy and smart LED. |
| Smart solar | providing wireless-enabled boosters to individual panels in a string improves |
| | efficiency of an entire solar system during diverse operating conditions (for |
| | example during shading and obscurance due to a presence of dirt), and |
| | reducing balance of systems cost for commercial solar installations. |
| | Integrating output from solar units to real-time operations and maintenance |
| | processes and renewable energy markets enables large-scale solar farms, |
| | as well as commercial off-grid solar deployments to maximize output from |
| | their solar installations. |
| Smart | a service delivered for high-energy users, for example buildings and |
| demand | industries, by connecting their assets to utility's DR (demand response) |
| responses | programs through an automated model using open standards framework. |
| | This service enables utilities to improve their demand forecasting, to shave |
| | peak loads and to allow building/factory owners to receive and track energy |
| | credits. |
| Real-time | by using a mobile-first approach, these services are delivered for the |
| mobile | iPhone, iPad through in-device specific applications; “iPhone” and “iPad” are |
| access | registered trademarks. For example, such real-time mobile access is |
| | capable of providing a consolidated view of all smart building services, |
| | wherein real-time alerts or action requests are sent through mobile |
| | communication networks for allowing information access anywhere/anytime. |
| Combining | by combining real-time performance of business processes, people and |
| enterprise | tracking KPI's from enterprise systems which, when combined with apps |
| and asset | delivered from Asset intelligence providers, provides an enterprise with an |
| intelligence | integrated view of the business: Business Process, People and Assets. This |
| | is presented through a set of interactive dashboards highlighting |
| | performance measures against benchmark, targets and forecast. These |
| | dashboards also allow forecasting for each of the KPI's. |

Hence, the technical platform as disclosed is capable of contributing to a variety of functions as aforementioned and illustrated in FIG. 1. Advantageous features of the technical platform are segmented across areas as provided in Table 4:

TABLE 4
Advantageous features of the technical platform

| Advantage | Detail |
|---|---|
| Low- | Low-power reference design using a single hardware |
| power | electronic circuit board design supporting multiple variations |
| reference | that can interface with a variety of sensor inputs, for |
| | example 4 mA to 20 mA signal format, ratio metric and pulse |
| | output from different sensor types and assets such as pumps, |
| | motors, analogue sensors, solar panels and lighting units. A |
| | principal objective of the hardware is to provide digital |
| | connectivity to these end assets by sourcing real-time data and |
| | sending such data over wireless communication routes. |

The infrastructure 2 has following unique features as provided in Table 5:

TABLE 5
Unique features of the infrastructure 2

| Unique feature | Detail |
|---|---|
| Tracking, | An ability to track, monitor, optimize and manage large-scale wireless |
| monitoring and | sensor networks of minimum 200 nodes in each network that provide |
| optimization | real-time battery and current charging status across the nodes. These |
| | networks consist of battery-powered or energy-harvesting nodes that |
| | form a mesh communication network with wireless communication |
| | technology licensed from a third party. Software codes are beneficially |
| | implemented on hardware of relay nodes to store and transmit data |
| | representative of the current battery charge status and to share the |
| | network condition status. |
| Open source | An open source cloud platform is used that stores and analyses |
| cloud platform | granular real-time sensor data. This cloud platform supports both public |
| | hosting as well as private cloud hosting. Proprietary contemporary |
| | Cloud Foundry is beneficially used for this purpose. Software codes are |
| | implemented on this platform to store real-time sensor data of different |
| | parameters such as current, power, voltage, flow, pressure, temperature |
| | that are measured every 10 seconds or more frequently. |
| Statistical | The platform applies statistical modeling tools and next generation |
| modeling tools | prediction modeling languages for purposes of analysis and forecasting. |
| | These tools are beneficially used to implement programmatically |
| | specific forecasting algorithms. |
| iSense/Control | iSense/Control events: the platform comprises a |
| events | recommendation engine that provides “control events” used by |
| | operations teams to trigger control functions in various assets. These |
| | events can be employed for various purposes, for example |
| | recommended pump schedules based on future building occupancy, |
| | ambient temperature and/or forecasted optimum system efficiency, |
| | automated demand response event-based recommendations amongst |
| | others. These events are based on past data analysis and by |
| | forecasting future impacts. These events are stored in the cloud |
| | platform and they activate control triggers to this device based on |
| | specific events. This is a new model of implementing control solutions |
| | that reduces complexity at the hardware end, re-uses existing control |
| | hardware that is already available within the asset and puts more effort |
| | on delivering intelligence through the wireless network and the cloud |
| | platform. |

The service layer 3 includes following unique features as provided in Table 6:

TABLE 6
Unique features of the service layer 3

| Feature | Detail |
|---|---|
| Apps | Delivering end-to-end services for target-specific vertical application |
| | areas through individual apps (software applications). For example, the |
| | smart facility service is focused on improving resource efficiency of |
| | facilities and engaging their tenants in energy optimization programs; |
| | “resource” pertains to one or more of energy, water and CO2. The smart |
| | facility service is targeted for industrial facility owners. The smart solar is |
| | focused on improving individual panel efficiency of solar photovoltaic (PV) |
| | systems in various operating conditions such as shading, obscurance by |
| | dirt on panels and thereby reduce the balance of system cost. The smart |
| | solar is targeted towards commercial owners of solar PV systems and |
| | large-scale solar developers. The smart DR is a service targeted towards |
| | utilities and large energy users that provide a secure demand response |
| | implementation platform. The smart assets are targeted towards OEM's, |
| | for example pump manufacturers, heavy machinery providers, pipeline |
| | owners in oil and gas refineries and water utilities amongst others. |
| Business model | The business model of delivering these services through “Pay-as-you- |
| | use” model enables not only a reduction in upfront capital expenditure but |
| | also aligns the value from this solution to usage of resources by |
| | customers. It also demonstrates the efficiency of the solution. Standard |
| | financial models have been developed to demonstrate a transparent |
| | payback computation to these customers. |

These aforementioned services are open in nature and all delivered from the same infrastructure. External developers are beneficially able to create similar vertical services for specific industries. Advantageous aspects of the technical platform and associated services are segmented across the areas as listed in Table 7.

TABLE 7
Advantageous aspect of the technical platform pursuant to the
embodiments

| Advantage | | | |
|---|---|---|---|
| Area | Hardware | Infrastructure | Services |
| Cost and | (i) Using lower cost | (iv) Ability to manage | (vi) Ability to |
| technology | ARM MCU's and energy | large-scale wireless | deliver services |
| | harvesting provides a | sensor networks through | through annual |
| | price advantage. | real-time monitoring of | subscription (“pay- |
| | (ii) Offshore model | individual relay nodes. | as-you-use”) model. |
| | for design and | (v) Using open | (vii) End-to-end |
| | production gives ability to | source cloud platform | services delivered |
| | scale hardware | enabling to deploy in both | with average |
| | development faster. | public and private clouds. | payback model of 18 |
| | (iii) Retrofitting to | This allows branding of | to 36 months. |
| | existing sensors, pumps, | this infrastructure for | (iii) New value-added |
| | and assets makes the | OEM's. | services developed |
| | implementation easier | (iii) Ability to handle real- | from the real-time |
| | with limited intervention | time sensor data and | data being acquired |
| | on existing infrastructure. | implement analysis, | by the system. |
| | (iv) It is envisaged to | forecasting algorithms on | |
| | make the reference | the data. | |
| | design available to | | |
| | OEM's for them to | | |
| | manufacture these units | | |
| | with their designs. | | |
| Feature | (viii) Complements | (x) Through a hybrid | (i) Delivers end-to- |
| | existing sensors, motors, | cloud model, it is feasible | end services for |
| | pumps and asset | to deliver individual | implementing |
| | management systems. | services that are branded | proactive/predictive |
| | (ix) Wireless | for OEM's; this hybrid | maintenance, energy |
| | enablement in | model is delivered from | and water efficiency |
| | conjunction with | the public data centers or | measures. |
| | microcontrollers allows | OEM's data center. | |
| | analogue data to be | (xi) Ability to analyze | |
| | converted to digital | real-time sensor data | |
| | format for data reuse and | including structuring data | |
| | being transferred over | and forecasting using | |
| | wireless mesh networks. | statistical programs. | |
| | (iii) Retrofit model- | (iii) Storage of control | |
| | reducing complexity for | signals on the cloud | |
| | OEM's and asset | platform, which allows to | |
| | owners. | send the signals to the | |
| | | end devices, based on | |
| | | changing conditions. This | |
| | | allows to reduce | |
| | | complexity on the | |
| | | hardware. | |

| | |
|---|---|
| Business | (xii) Incorporates hardware (end units), wireless mesh communication |
| model | network and the end user application through a single service charge. |
| | (xiii) The service charge is linked to the number of hours the end asset |
| | runs, which clearly aligns the value, generated from the service to the end |
| | asset operations. The more usage of this service will yield higher value from |
| | a perspective of reduced cost and increased revenues. |
| | (iii) Known contemporary business models in this industry have always been |
| | upfront CAPEX investment for the hardware and licensing cost for the |
| | wireless network and the end user software application. This contemporary |
| | model is being turned on its head through the annual service charge. |

The embodiments are described in the foregoing in very general terms, including its associated business model. Moreover, the embodiments will be now further elucidated in further detail with reference to a few preferred embodiments in the following paragraphs. Such embodiments as illustrated are only for the sake of understanding and not any sort of limitation. The embodiments include all aspects as would be understood by persons skilled in the respective art.

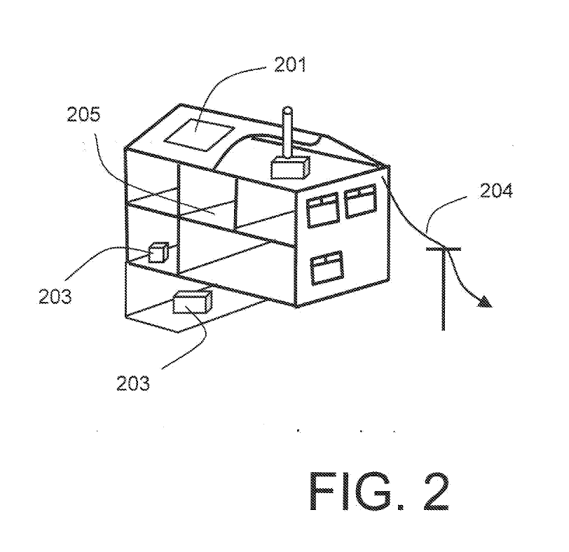

In FIG. 2, there is illustrated a preferred embodiment of the technical platform of the embodiments applied in a smart facility solution. The smart facility solution is a service which is focused on achieving functionality as provided in Table 8 for commercial facility owners:

TABLE 8
Functionalities of the smart building solution

| Functionality | Detail |
|---|---|
| Reduce | Reduced energy and water consumption in pumps and |
| consumption | motors through real-time monitoring, control and |
| | installation of energy effective equipment |
| Occupancy | Installing LED's, daylight and occupancy sensors to |
| sensors | implement intelligent lighting control solutions that reduce |
| | energy consumption and enable employees to access |
| | personal lighting zones |
| Employee | Engaging employees in the building by informing them of |
| engagement | their personal and building resource consumption. |
| | Implementing game mechanics to engage employees in |
| | reducing energy usage through ideas, personal badges |
| | through a mobile-only application. |

The smart building service, denoted by 201 in FIG. 2, consists of solution modules as provided in Table 9:

TABLE 9
Solution modules of the smart building service 201

| Solution module | Detail |
|---|---|
| A smart water | A smart water module 203 is operable for targeting energy and water |
| module 203 | efficiency at air handling units (AHU's) and chilled water units in |
| | commercial buildings. This smart water module 203 provides in- |
| | depth views of the building's cooling and heating load and energy |
| | consumption. |
| A smart energy | A smart energy module 202 is operable for targeting energy |
| module 202 | efficiency of pumps and motors in the buildings. The smart energy |
| | module 202 also incorporates control signals. |
| A smart LED | A smart LED module 205 for installing daylight and occupancy |
| module 205 | sensors with the LED's enable lighting to be controlled based on |
| | changing light conditions and occupancy in the building. |
| A smart demand | A smart demand response module 204 additionally provides smart |
| response module | demand response by optimizing equipment performance based on |
| 204 | utility price signals. |

In the smart building service 201, employee engagement is enhanced by providing a mobile version of the one or more software applications (apps) employed for implementing the smart facility service 201, wherein the mobile version allows operators to have real-time alerts and acceptance of control events.

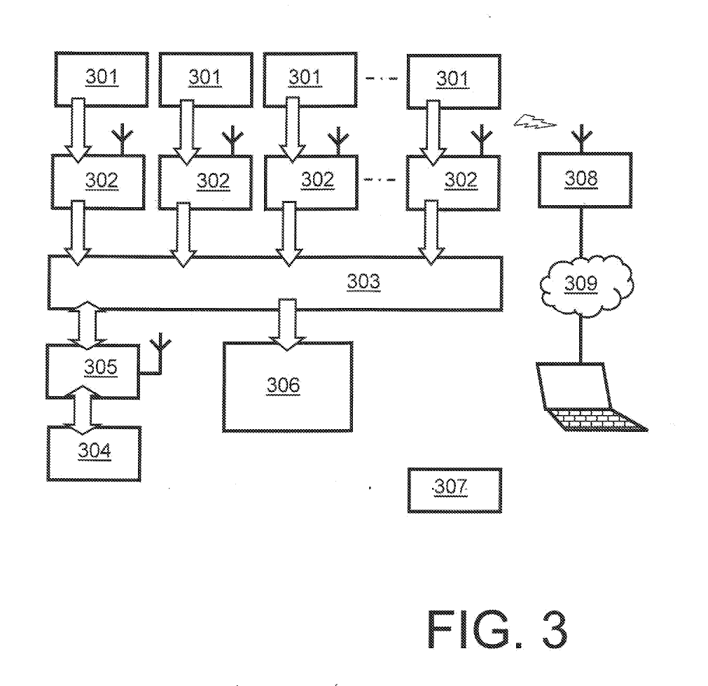

In FIG. 3, there is provided an illustration of a preferred embodiment of a technical platform according to the embodiments, wherein the technical platform is applied in a solar panel arrangement. As shown in FIG. 3, a series of solar panels 301 are operatively separately associated to a smart panel 302, which is monitored by a central solar charge controller 303. The solar charge controller is further operatively associated to a smart meter 305, a battery bank 304, and electrical load 306 and is supported by existing hardware 307. The smart panel 302 possesses wireless transceivers, which connect users via a wireless gateway 308 and a communication network 309, for example implemented via the Internet.

The technical platform pursuant to the embodiments are operable to provide a smart solar service which is focused on achieving following objectives, as provided in Table 10, for solar system owners and solar power producers:

TABLE 10
Objective of the smart solar service

| Objective | Detail |
|---|---|
| To optimize solar | An objective to optimize solar panel 301 performance by introducing |
| panel 301 | panel-level monitoring and optimization through use of DC-DC power |
| performance | boosters. An associated hardware unit maximizes solar panel output |
| | during shading and dirt conditions, as well as during normal conditions. |
| | A wireless-enabled unit is employed that reduces balance of system |
| | costs and normalizes system output. |
| To optimize | An objective to optimize operations and maintenance by integrating |
| operations and | real-time solar panel performance data to the operation and |
| maintenance | maintenance business process for reducing the solar system |
| | maintenance cost. |
| To provide | An objective to provide renewable energy (RE) certificate trading by |
| renewable | integrating real-time solar system generation output to external market |
| energy (RE) | based RE trading scheme for allowing solar plant operators to |
| certificate trading | appreciate in real-time the value created and make appropriate trading |
| | decisions. |

The smart solar service consists of the following independent modules as provided in Table 11:

TABLE 11
Independent modules of the smart solar service

| Independent | | |
|---|---|---|
| module | Detail | Sub-detail |
| A smart | A smart panel 302 | (i) An arrangement to communicate module |
| panel 302 | including a retrofit | level performance to the smart solar monitoring |
| module | hardware module | software conveying a range of module specific |
| | (meter and | operational data to identify trends and proactive |
| | converter) attached | maintenance. |
| | to the individual | (ii) An arrangement to maintain a fixed string |
| | panel's modules. | voltage through the DC-DC conversion ensuring all |
| | The hardware | the solar panels operate at a constant voltage |
| | module has key | regardless of the number of modules in the string |
| | functions as listed | and the performance of each solar panel. |
| | on the right-hand- | Maintaining a fixed DC string voltage independently |
| | side herewith. | of panel voltage ensures optimal efficiency of DC to |
| | | AC inversion by the inverter regardless of the string |
| | | length or temperature. Moreover, maintaining the |
| | | solar panel at a lower voltage improves safety at |
| | | different installation conditions. |
| | | (iii) An arrangement to provide a module-level |
| | | MPPT (maximum power point tracker) through a |
| | | highly optimized algorithm ensuring each module is |
| | | kept at MPP, thereby preventing power loss in |
| | | scenarios of module mismatch and shading |
| | | conditions. Such an approach is faster and more |
| | | responsive than the tracking undertaken at inverter- |
| | | only level. Optimized MPPT per modules potentially |
| | | delivers up to 25% more power dues to higher |
| | | tolerance to shading, tolerance compensation and |
| | | better MPPT tracking. |
| | | (iv) An energy harvesting module that trickle charges |
| | | the relay nodes as well as the smart panel unit. |
| An | An arrangement for | |
| arrangement | REC trading, namely | |
| for | added to the smart | |
| renewable | solar software that is | |
| energy | used to provide real- | |
| certificate | time aggregation of | |
| (REC) | the generated | |
| trading | output, trends and | |
| | enables end users to | |
| | make decisions with | |
| | respect to trading of | |
| | the REC's | |
| | (renewable energy | |
| | certificates) | |

The smart asset service is focused on providing real-time wireless connectivity for commercial and industrial assets and solving real-time World problems which have been hard to resolve previously due to lack of access to data. This connectivity beneficially enables OEM's to deliver the following:

(i) to develop an Opex-based business model; and
(ii) to implement new maintenance and also to support a model, which relies on real-time data and is integrated to internal processes.

One of the services that has been developed, pursuant to the embodiments, in the above context is “Smart Pipelines” for oil, gas and water utility industries with a specific solution for “Corrosion Management”. Such a service is achieved by providing wireless ultrasonic sensors installed on pipelines, for undertaking thickness monitoring in real-time of the pipes across various temperature zones. Target industries for this service are oil, gas and water utilities. Interfacing to pipeline walls for sensing purposes is beneficially executed with an ultrasonic thickness measurement sensor as aforementioned.

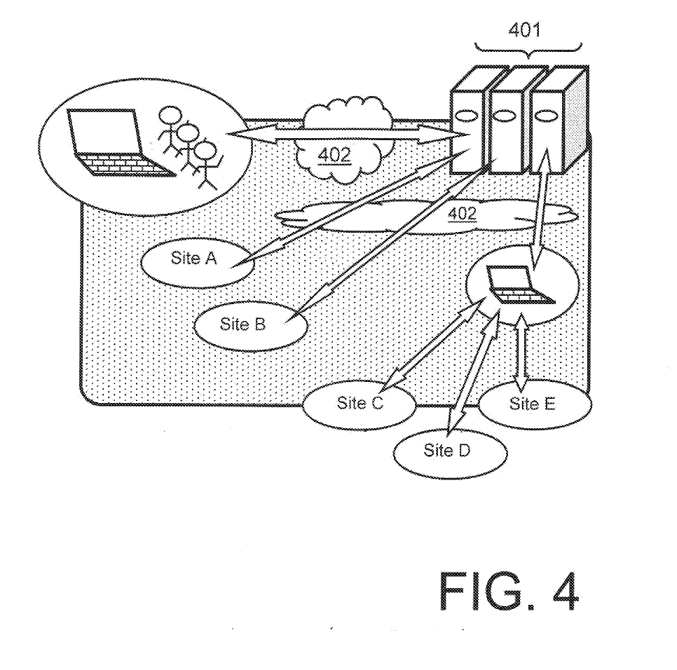

In FIG. 4, there is provided an illustration of a preferred embodiment of a technical platform pursuant to the embodiments applied in a smart demand response (DR) service. The smart DR service is aimed to provide a platform that can support implementation of DR programs by connecting high energy consuming assets with a price signal system provided from a utility supplier of resources. The smart DR service is aimed to achieve benefits for utilities and large energy users such as commercial buildings, process industries and water utilities.

For example, the smart DR service is capable of optimizing the operations of high-energy consuming equipment, for example pumps and motors, in line with price signals provided from utilities. Optimizing operations include, for example, reducing the pump speed during peak load, which results in reducing the pump energy consumption.

As illustrated in FIG. 4, the smart DR service process is controlled by a demand response automation service 401 accessed through a communication network 402, for example via the Internet, by various operators. The embodiments employs a modular approach to integrate three mutually different components, and several new elements have been integrated into each module as provided in Table 12:

TABLE 12
Modular component for implementing the embodiments

| Modular component | Details |
|---|---|
| Hardware: hardware | (i) An analogue-to-digital converter (A/D): this allows |
| integrates three | interfacing with existing analogue sensors, which are already |
| elements on a single | installed in numerous industrial and commercial establishments. |
| reference electronic | This contains a microcontroller unit (MCU) that is used for |
| circuit board | controlling the hardware. |
| | (ii) Wireless motes: for interfacing between the MCU and |
| | wireless motor to ensure that sensor data is picked up and |
| | transmitted using the wireless communication network. |
| | (iii) A reference electronic circuit board that includes wireless |
| | antenna and other peripherals. |
| Wireless sensor | (iii) Relay nodes transmit their current, battery charging status |
| network: a mesh | over the network. This allows for tracking remotely the status of the |
| network is formed | mesh network and for taking appropriate action in an event that one |
| using established | of the nodes is close to “falling over”, namely failing or becoming |
| industry standard | non-functional. The relay node includes an energy harvesting |
| Wireless HART | module which trickle charges the battery in different indoor and |
| standard. The | outdoor operating conditions. |
| specific invention is | (iv) A web-based network management tool has been |
| concerned around the | developed that captures all the data points from individual nodes |
| relay modes which | and merges it with the wireless data (signal strength and so forth) |
| exhibit operating | that is picked up from the network manager to plot an overall |
| characteristics as | network strength. |
| provide herewith on | (iii) The network management tool is also used to identify the node |
| right-hand-side: | location and also optimize the network at a later stage based on |
| | actual performance. |
| Cloud-based software | (v) Private and public cloud: supports scenarios where |
| platform: the cloud- | customers do not want their data asset data to be stored outside |
| based software | their data center. A framework is beneficially devised to support |
| platform uses an | both scenarios but deliver it through a single code base. |
| open source cloud | (vi) Mobile data visualization: develops a framework for |
| stack which has been | delivering mobile data visualization with dashboards that are |
| customized further to | automatically created in HTML5. These dashboards act as native |
| support the following | applications and can be deployed across multiple interfaces. |
| characteristics: | (iii) Intelligent Analytics: analysis of data is executed using various |
| | prediction and statistical tools that can be applied on large data sets |
| | for intelligence and insight. |

All the above are displayed through a multi-browser interface in both web (i.e. Internet) and mobile environments.

Another key area of the embodiments is its business model. The novelty and uniqueness of the business model have been elucidated in the foregoing. The embodiments combine the technology platform with a unique business model. Moreover, the technical platform has technical effect as aforementioned, for example via its use of sensors and related hardware. These two elements of the technical platform and its business model are mutually dependent, so it is not possible to deliver the business model on a “save-to-pay” basis without using the technical platform. Similarly, user end services would not be economical over existing known solutions, unless there is a differentiated business model as pertains for the embodiments.

In Table 13, there is provided an overview of the comparative aspects of the technical platform of the embodiments as compared to existing known products:

TABLE 13
Comparative aspects of the technical platform pursuant to the
embodiments

| Invention | Comparison with known | |
|---|---|---|
| element | processes/products | Novel feature of embodiments |
| Smart | Known smart | Key novel features are: |
| infrastructure | infrastructure platforms | (i) the technical platform pursuant to the |
| technical | are essentially | embodiments does not rely only on cellular |
| platform | “Machine-2-machine” | communication networks as a connectivity |
| | platforms; for example, | option; the embodiments provides for multiple |
| | a known company | connectivity options, for example HART, |
| | “Axeda” provides a | 6LowPan, Cellular, Sub-1 GHz wireless |
| | platform, and delivers | communication and so forth; |
| | different services for a | (ii) known implementations are based on |
| | variety of industries via | server-based offerings, whereas the technical |
| | the platform | platform pursuant to the embodiments includes |
| | | new features that are added to the server; the |
| | | technical platform has an “end user service” |
| | | based offering, wherein new services are |
| | | added to applications for the end user; |
| | | (iii) known implementations are a |
| | | development platform and do not give access |
| | | to the data for end users. The technical |
| | | platform pursuant to the embodiments provides |
| | | a development environment which focuses on |
| | | providing access to the sensor or asset data, |
| | | thereby enabling users to build new services |
| | | on top of applications; |
| | | (iv) the technical platform pursuant to the |
| | | embodiments provides hardware, |
| | | communications network and software |
| | | platform, whereas known systems only provide |
| | | a software platform. |
| Smart building | Known building | The technical platform pursuant to the |
| | management systems | embodiments provides: |
| | are comparable to | (iv) wireless-enabled hardware units which |
| | Smart building service. | can be retrofitted to assets such as cooling |
| | These known systems | systems, pumps, lighting systems and so forth, |
| | are proprietary in | and which are operable to monitor asset |
| | nature and do not | condition, ambient condition and energy |
| | interoperate with other | consumption at a granular level; |
| | external systems in | (v) interfacing to existing control systems |
| | general. Most known | and provides signals based on changing |
| | systems do not track | operating conditions; by analyzing sensor data, |
| | energy consumption | trigger control signals are provided wherein |
| | and do not provide real- | sensors are placed remotely relative to control |
| | time control, namely | systems; in comparison, known systems have |
| | they are based on | sensors and control system spatially collocated |
| | preset controls and | in one unit; |
| | primarily hardware | (iii) provides software that makes building data |
| | installed at customer | accessible to technical and non-technical |
| | premises. | users, for example by employing open data |
| | | standards (open source) and web-based |
| | | interface stacks. |
| Smart solar | Known solar system | The technical platform pursuant to the |
| | monitoring and | embodiments includes the following novel |
| | optimization is | features: |
| | executed at an array | (vi) wireless-enabled hardware units which |
| | level, which results in a | can be retrofitted to existing solar panels, |
| | lack of clarity for each | wherein the hardware units are operable to |
| | solar panel | monitor solar panel current, voltage at |
| | performance. | individual solar panels; |
| | Moreover, in known | (vii) distributed MPPT (maximum power |
| | systems, shading and | point tracking) and DC-DC voltage regulation |
| | dirt on one of the solar | which enables maximum power to be |
| | panels can affect a | generated from a given solar panel as well as |
| | current output from an | up-convert/down-convert total output from the |
| | entire string of such | solar panels. The hardware unit is powered by |
| | solar panels, namely | energy harvesting, namely provides its own |
| | has a potential of | operating power; |
| | reducing energy output | (iii) real-time data collection is provided which |
| | from the entire string of | enables service management processes to be |
| | solar panels. | automated via the technical platform. |
| Smart Demand | Known DR services are | The technical platform pursuant to the |
| Response (DR): | manual in nature, for | embodiments: |
| using SmartDR | example in a given | (viii) employs one gateway supporting |
| gateway | morning, a given utility | multiple standards for different asset types; the |
| | an email/xl sheet | gateway has intelligence to direct control |
| | highlighting the peak | signals to specific asset types; |
| | period during the given | (ix) connecting cloud-based platforms to |
| | day; based upon the | utility DR systems via use of an open standard, |
| | data, a known facility | for example “Open ADR”; |
| | manager either | (iii) delivering DR based on real-time data |
| | switches on or switches | retrieved from utility systems as well as |
| | off specific equipment | performance of the assets. |
| | to provide demand | |
| | response; this enables | |
| | the known facility to | |
| | earn credits in their | |
| | monthly energy bill, for | |
| | example by providing | |
| | “peak shaving” services | |
| | to the utility. | |
| Smart | Known oil and gas | The technical platform pursuant to the |
| Assets/Smart | fields and water utilities | embodiments: |
| Pipeline: | employ relatively low | (x) using wireless-enabled wall thickness |
| providing | technology measures to | sensors that are operable to source real-time |
| functionality of | identify wall thickness | data on thickness status over a period. This |
| Wireless | issues and leaks in the | enables trends to be identified; |
| Corrosion | pipelines, wherein | (xi) a mesh network is deployed to |
| Management | typically these have | transport data in real-time; all hardware is |
| | required manual | beneficially ATEX certified, including sensors |
| | inspection with limited | and associated relay nodes for conveying |
| | access to difficult | sensor output data; |
| | inaccessible areas. | (iii) a cloud-based platform arrangement is |
| | | operable to analyze data in real-time and |
| | | provides predictive/real-time capability for |
| | | operations and management teams. |
| Business model | Known industrial | The technical platform includes following |
| | automation and control | features: |
| | solutions are delivered | (xii) customers are charged based upon a |
| | through a CAPEX | number of hours a given machine or asset is to |
| | model, wherein | be monitored and controlled; this allows |
| | customers have to buy | alignment of value from solution to operations |
| | up-front equipment to | in practice, for example allows a “pay-to-save” |
| | be able to monitor and | business model to be implemented; |
| | control assets; such a | (xiii) savings in energy cost, asset |
| | business s model has | management costs are achievable, for example |
| | been prevent for at | via extra credits from utilities for providing |
| | least the past 20 years. | services such as DR services to the utilities; |
| | | (xiv) the business model comprises: |
| | | setup and commissioning charges; and |
| | | charge-per-asset-per-running hour, for |
| | | example £0.50 per pump per hour. In other |
| | | words, charges are made pursuant to the |
| | | business model only for the number of hours a |
| | | given pump, in a facility supported from the |
| | | technical platform, is running. |

The embodiments are, as elucidated in the foregoing, primarily focused at combining the review of multiple parameters from multiple assets, for example wherein the parameters are communicated via a wireless communication network, to identify patterns of inefficient asset performance. In order for asset performance to be properly assessed, monitoring at an individual asset level, for example device level, namely “granular” level, is required. Data from such an individual asset level derived from multiple assets make up a system of data, which is then compared using the aforesaid technical platform. Beneficially, the communicated parameters are aggregated and analyzed in the technical platform to identify performance of a system being monitored, and areas of the system where efficiency can be improved, for example based upon the acquisition of real-time data. Such analysis enables control settings to be reset for example, efficiency targets can be set, predictions can be made, and additionally efficiency implementation plans can be designed.

Conveniently, the technical platform includes an overall control platform, referred to as “BRAINS.APP” that connects wirelessly to different assets, for example sensing devices. The technical platform is capable of addressing a contemporary problem of inaccuracy of energy consumption measurements as determined from individual asset performance, wherein the technical platform is operable to identify patterns and relationships to identify opportunities to improve efficiency of the whole system, for example a large manufacturing plant such as a Silicon integrated circuit foundry for manufacturing microprocessors where installation of measuring equipment is often not straightforward without adversely affecting production and operation of the large manufacturing plant.

The technical platform beneficially performs a method including the following steps:

(a) acquiring data in real-time from multiple assets, for example devices, via a wireless communication network;
(b) analyzing the acquired data to identify patterns and relationships in the acquired data, thereby constructing a system model for the multiple assets; optionally such analysis employs a degree of data aggregation;
(c) applying simulation, for example Monte Carlo simulation, to determine where energy savings and/or increases in operating efficiency can be achieved; and
(d) providing control information, for example definition of trigger events, reports, analyses which can be used to control the multiple assets to improve their manner or operation, for example save labor costs, reduce maintenance costs and improve accuracy of energy consumption monitoring.

Energy bills for large semiconductor foundries can often be millions of £'s (GBP) per year, wherein application of the technical platform pursuant to the embodiments is capable of providing savings in such bills in an order of 10% to 15%.

When implementing the technical platform, it is desirable that the SmartEnergy system is connected to a same power circuit as an asset to be measured, for example a pump, an oven, or similar. Moreover, it is desirable, in conjunction with the communication of sensor data to the technical platform, to employ a standardized data format, for example a 64-bit data format; this is an important part of the solution provided by the technical platform.

As aforementioned, the technical platform is suitable for being applied to a wide range of facilities and industries, for example: foundries, steel industry, petrochemicals industry, nuclear industry, transport facilities, water treatment works, food processing facilities and so forth. It is not unusual, in practice, for sub-section of a foundry to include 12 assets that are monitored via 54 sensors, wherein the entire foundry includes more than 2000 assets; real-time data from such a facilities represents a heavy computational burden to process and analyze, namely a function performed by the aforesaid technical platform.

Beneficially, the assets are arranged to identify themselves to the technical platform, for example using an MacID reference code representative of the type of, or each, individual asset, wherein the platform is provided beforehand with a list of typical assets and their associated technical performance; for example, the list and the MacID reference code includes manufacturer type (Grundfos, KSP, and similar for pumps). Beneficially, the assets, via their monitoring modules, are operable to declare their unique identifies, include device-type information, so that the technical platform is more easily able to cope with new assets being added to a facility, whilst the technical platform is performing its aforesaid functions in real-time. Such functionality is highly beneficial when the facility must be kept operative on a continuous basis, for example a nuclear facility, a water treatment works, a steel foundry.

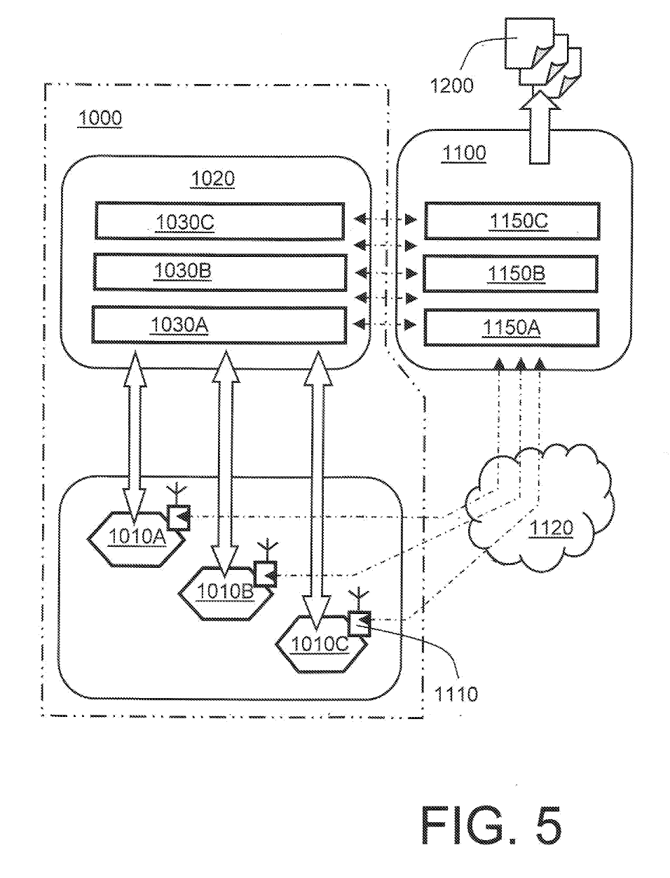

Referring to FIG. 5, a facility is denoted by 1000 and includes a production arrangement including multiple assets 1010A, 10108, 1010C which are provided beforehand with sensors and controls which communicate via a pre-installed communication network to a control facility 1020 which has potentially multiple layers 1030A, 1030B, 1030C of software control. An operator of the facility is desirous to improve efficiency of the facility and retrofits a technical platform pursuant to the embodiments, denoted by 1100, to the facility. The technical platform 1100 employs one or more modules 1110 which are attached to the assets 1010A, 10108, 1010C for monitoring operation of the assets 1010A, 10108, 1010C and providing measurement data, at granular level, communicated wirelessly via a wireless communication network 1120 to the technical platform 1100. The technical platform 1100 is optionally, at least in part, cloud based. Moreover, the technical platform beneficially employs open source software so that the operator can access the technical platform 1100 to configure its manner of operation. Optionally, the technical platform 1100 receives data from the one or more layers 1030A, 1030B, 1030C of the control facility 1020 in addition to data provided from the one or more modules 1110. The technical platform 1100 is optionally operable to provide control signal for influencing operation of the assets 1010A, 10108, 1010C in a manner which does not interrupt operation of the assets 1010A, 10108, 1010C, but is capable of improving an efficient of operation of these assets 1010A, 10108, 1010C. Moreover, the technical platform 1100 is operable to generate reports and analyses 1200 which are of benefit to the operator for management purposes in respect of the facility 1000. Optionally, the technical platform 1100 is operable to communicate with utilities, for example energy supply companies, for trading in renewable energy certificates (REC). Beneficially, the technical platform 1100 is costed to the operator of the facility on a basis of hours-of-operation per given asset when the technical platform 1100 is operable to provide benefits in respect of improving operating efficiency in respect of the given asset; such a business model is differentiated from a conventional approach where the operator must pay up-front for additional conventional monitoring and control system that may be added to the facility 1000. Optionally, the technical platform 1100 is implemented using computing hardware which is operable to execute one or more software products, wherein the software products are disposed in a plurality of software layers 1150A, 1150B, 1150C and are operable to exchange data therebetween; certain of the software layers are dedicated to providing specific types of services from the technical platform 1100, and certain of the software layers are beneficially pre-programmed, for example a pre-programmed service layer 1150A.

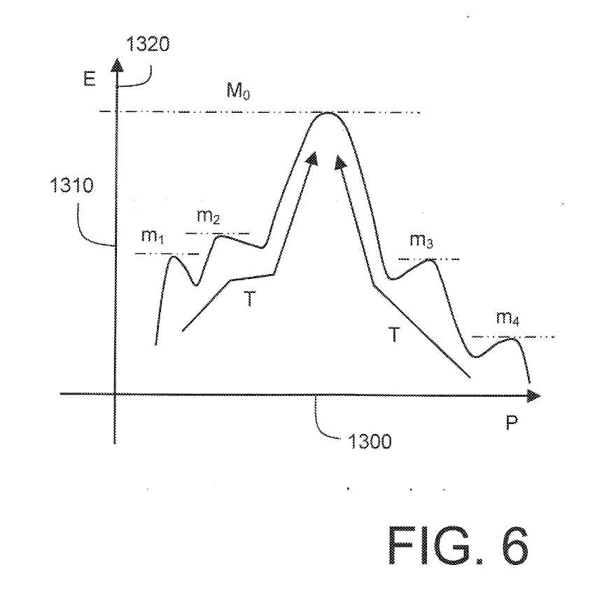

The technical platform 1100 is capable of providing efficiency improvements by combining information obtained at granular level from the assets 1010 as well as at a high system level from the control facility 1020. Referring to FIG. 6, there is shown a graph having an abscissa axis 1300 denoting choice of control parameters P for operating an example system having multiple assets 1010, for example an array of solar panels as aforementioned, a bio-fuel organic waste digester or similar, and an ordinate axis 1310 denoting overall efficiency or performance E of operation of the system. The graph represents a simplified presentation of a complex multidimensional space in which operating solution can be found for the system to ensure that it operates with maximum performance or efficiency E. Beneficially, each asset 1010 is operable to communicate from its associated module a signal m indicate of operating or efficiency of operation of the asset 1010 as perceived from a local perspective of the asset 1010. Moreover, the technical platform 1100 is operable to receive from one or more layers of software 1030 of the control facility 1020 signals indicative of an overall performance of the assets 1010, as perceived from an overall system perspective. Whereas the signals m allow each asset individually to be optimized for performance, giving rise to local optimization maxima, namely maxima m₁, m₂, m₃ and m₄ in FIG. 6, the assets 1010 mutually interact in operation such that an overall optimal system operating regime is determined from a principal maximum denoted by M₀ in FIG. 6. By processing the signals m from the assets 1010 and receiving from the control facility 1020 information regarding a manner in which the assets 1010 mutually interact when in operation, the technical platform 1100 is operable to determined optimum trajectory vectors T within the multi-dimensional solution space represented in FIG. 6 and thereby find an optimal manner, namely the principal maximum denoted by M₀ in FIG. 6, in which the assets 1010 can be operated whilst concurrently fulfilling their functional purpose, for example solar power generation, bio-fuel production and similar. The technical platform 1100 beneficially determines the principal maximum denoted by M₀ in FIG. 6 by employing a combination of Monte Carlo modeling and vector analysis.

### Example Embodiment

The following embodiment is for an installation of the technology 1100 platform for providing technical services where the facility is a full-service semi-conductor foundry. Real time tracking and analysis of consumption data of the facilities multiple assets is possible by each asset having at least one sensor unit which has hardware containing a low power ARM microprocessor for processing the data. The sensor unit monitors and processes the status/operating condition of the asset in real time and feeds information indicative of the energy consumption and efficiency of the asset, such as a pump, fan, compressor, cooling tower, HVAC or furnace, to the overall analysis platform, namely the BRAINS.APP system. The analysis platform delivers a portfolio of smart applications (Apps) used to generate a baseline of the multiple assets being monitored, and benchmarks their performance against past non-real time data pertaining such assets to identify the overall system efficiency. The analysis of the aggregate consumption data is executed online via the Internet or through wireless communication to portable communication devices. The BRAINS.APP, which can be in the form of a Mobile App software solution, allows the user to give automated or user-selected proactive and predictive instructions on how to make the overall system more efficient and achieves post-optimization of assets or even indicates needed replacements. This provides an advantage of being able to improve maintenance and services of assets without needing to close large parts of the facility, namely provides an advantage of performing a monitor function and allowing for decision making on a system level but act on an individual asset level.

The facilities systems targeted in the embodiment includes:

Process Cooling Water (PCW) System with 8 pumps, 4 heat exchangers, 5 PCW filters;

Clean Compressed Air with 8 compressors, cooling water fans and cooling water pumps;

Make up air units;

Vacuum pumps.

The sensor unit for each asset includes:

sensors for accessing the real time data from the asset

a. 3 Phase motor energy providing current, voltage, power for each phase connected to source
b. —Interface with existing analogue Pressure, Temperature sensors through 4-20 mA

Wireless enabled

Wireless Sensor Network: a mesh network for transmitting real time data using industrial automation standard Wireless HART.

Beneficially, analysis of the facility is performed over several weeks for gathering large amounts of data at individual asset level. The sensing units can be adjusted to monitor at given intervals to avoid excessive data, or too little data, being collected. The analysis performed by BRAINS.APP allows not only for current optimization of the system level, but also the future prediction of, for example, energy consumption. This allows for greater flexibility of the facility managers who can purchase future energy credits, thereby allowing more cost effective running of the facilities on a lower cost base. In certain tests, it has been identified that the water consumption of a foundry was improved by more than 13% over an extended period of 2 months, by applying the embodiments. Similar efficiency gains of energy consumption were seen on electricity in the range of ca 12-17%. This results in substantial savings in running costs of foundries of many million Euros.

In an alternative embodiment of the present disclosure, there is an installation of the technical platform that allows for fewer sensors to be installed than what is possible in conventional management systems used in controlling and monitoring e.g. industrial plants, building or supply chain information. Known management systems for controlling assets are proprietary and in order to control asset performance needs a large number of sensors. These sensors are costly and require substantial investments. However, the disclosed embodiment, which is called the IntelliSense.io technology platform, has developed a method of analysis that simulates the wireless sensor's performance depending on the industrial process in specific facilities and generating representative models. These models help by reducing the number of sensors required to profile and operate a system efficiently. These models are further developed at a system level and simulate individual asset, such as pumps, furnaces, coolers, etc., performance depending on various operating conditions of temperature, pressure, installation type and more. These models reduce the need for costly sensors to be installed at each and every part of the system flow. By identifying different characteristics that impact system performance from the model, the method is able to optimize the number of sensors needed for high performance sensing and place the sensors at specific locations in the process flow. This helps in optimizing the number of sensors and placing them at adequate areas across the process flow that can profile, predict and optimize system performance. Further, the analysis of the data from the sensors allows new optimized operation parameters to be identified for the system at an asset level as well as at the system level. When the technical platform is installed in large manufacturing plants or high value processes it is preferable not to do real time control of the system. It is then better to only adjust the operation conditions of the system during maintenance or off peak times. This reduces the risk of any errors in the settings occurring and also allows for the models to be more robust as they are basing their recommendations on large sets of data over an extended period of time, which further improves their performance over traditional so called real-time control systems.

Modifications to embodiments described in the foregoing are possible without departing from the scope of the invention as defined by the accompanying claims. Expressions such as “including”, “comprising”, “incorporating”, “consisting of”, “have”, “is” used to describe and claim the embodiments are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

What is claimed is:

1. A technical platform for providing technical services, wherein the technical platform comprises a hardware arrangement which is operable to sense and process real-time data and/or signals occurring within at least one facility, and to transmit the real-time data and/or signals through communication medium, wherein the hardware arrangement is operatively connected to control and/or infrastructure layers for implementing overall control and responses to the real-time data and/or signals, and a pre-programmed service layer which is operable to receive and utilize the responses for management purposes for providing the technical service.

2. The technical platform as claimed in claim 1, wherein the hardware arrangement comprises sensors for sensing a plurality of inputs, and a wireless communication arrangement for transmitting data and/or signals received from the sensors to the control and/or infrastructure layers.

3. The technical platform as claimed in claim 2, wherein the sensors include audio sensors and/or temperature sensors with associated interfacing arrangements for analogue sensors.

4. The technical platform as claimed in claim 2, wherein the facility includes one or more assets or systems with one or more sensors for providing wireless communication of real time data of each asset or system over time.

5. The technical platform as claimed in claim 2, wherein the service layer utilizes non-real time data for comparing the real time data of the at least one facility to enable it to take proactive and predictive actions to intelligently operate one or more assets or systems in the facility.

6. The technical platform as claimed in claim 2, wherein the hardware arrangement is operable to interface with already-installed control and/or infrastructure to trigger control functions depending upon changes in operating conditions within the at least one facility.

7. The technical platform as claimed in claim 2, wherein the facility is a foundry and the one or more assets comprise one or more pumps, furnaces, compressor, heat exchangers and other equipment and systems.

8. The technical platform as claimed in claim 2, wherein the control and/or infrastructure layer comprises a wireless communication arrangement which is adapted to set protocols for receiving the real-time data and/or signals, a networks operation center (NOC), a pre-programmed software system for analyzing and responding to the real-time data and/or signals in an intelligent manner, and a cloud platform for handling data and time sharing resources of overall infrastructure.

9. The technical platform as claimed in claim 2, wherein the service layer is operable to provide recommendations through control events that act as triggers for steps in respect of facility services, wherein the facility services include at least one of:
(a) energy services;
(b) light services;
(c) water services;
(d) motor control;
(e) electricity services;
(f) LED-related services; and
(g) CO2 services.

10. The technical platform as claimed in claim 2, wherein the service layer is operable to trigger steps in respect of demand response services in industry with high energy consumption in peak hours, wherein the demand response services comprises demand forecasting, saving peak loads, and providing energy credits.

11. The technical platform as claimed in claim 2, wherein the technical platform is operable to be associated with a business model to deliver a “save-to-pay” model.

12. The technical platform as claimed in claim 2, wherein the technical platform integrates enterprise KPI's, wherein the enterprise includes processes and people, with asset performance KPI's to provide an integrated view of enterprise performance and forecast and/or predict future performance.

13. The technical platform as claimed in claim 2, wherein each asset is operable to generate an associated local performance indicative signal (m), and the technical platform is operable to receive the local performance indicative signals (m) of the assets, and information describing mutual interaction of the assets from the control and/or infrastructure layers, wherefrom the technical platform is operable to compute control parameters for achieving an optimal global operating performance (M₀) for the facility.

14. The technical platform as claimed in claim 2, wherein the real-time data of the one or more assets of the facility interfaces with the sensors in wireless communication devices, such as tablets, smartphones and laptops to access data, which is compared with enterprise data to identify intelligence and enable users to take proactive and predictive action on the operation of the assets.

15. The technical platform as claimed in claim 14, wherein the wireless communication devices have software applications allowing the multiple assets to be controlled and optimized remotely, in different geographically separated facilities or within the one facility, while interacting with multiple inputs of real time data from asset sensors or wireless communication device sensors.

16. A method of providing technical services via a technical platform, wherein the method includes:
(i) using a hardware arrangement of the technical platform for sensing and processing real-time data and/or signals occurring within at least one facility;
(ii) transmitting the real-time data and/or signals through communication medium, wherein the hardware arrangement is operatively connected to control and/or infrastructure layers for implementing overall control and responses to the real-time data and/or signals; and
(iii) using a pre-programmed service layer to receive and utilize the responses for management purposes for providing the technical service.

17. A software product recorded on machine-readable data storage media, wherein the software product is executable upon computing hardware for implementing the method as claimed in claim 16.
